(19) United States
(12) Patent Application Publication
(10) Pub. No.: US 2017/0330361 A1
(43) Pub. Date: Nov. 16, 2017

(54) Method of Producing an Augmented Reality Experience for a Remote Customer Via Linked Media

(71) Applicant: Christopher David Fisher, Littleton, CO (US)

(72) Inventor: Christopher David Fisher, Littleton, CO (US)

(21) Appl. No.: 15/597,139

(22) Filed: May 16, 2017

Related U.S. Application Data
(60) Provisional application No. 62/336,750, filed on May 16, 2016.

(51) Int. Cl. G06T 11/60; H04L 29/08; H04N 7/18; G06Q 30/06

(52) U.S. Cl. CPC G06T 11/60; H04N 7/183; H04L 67/12; G06Q 30/0613

(57) ABSTRACT

A consumer captures a photograph and associated video and transfers the media to a system server. The system creates a physical print and a unique identifier code of an image of the print. A user can display the print and when a mobile device is directed towards the presented print, the device will initially display the image and its surrounding background. The system then recognizes the presented image as being a system image via the unique code. The device requests the associated video across a network, the server sends the video, and the system then plays the video in the location on the device's display where the photograph image was being displayed previously. The surrounding background can continue to be displayed as well.

### CROSS-REFERENCE TO RELATED APPLICATIONS

This application claims the benefit of U.S. Provisional Patent No. 62/336,750 entitled Method of Producing an Augmented Reality Experience for a Remote Customer Via Linked Media and filed on May 16, 2016, which is specifically incorporated by reference herein for all that it discloses and teaches.

### TECHNICAL FIELD

The present invention relates generally to the field of augmented reality; more particularly, to the field of providing a remote customer an augmented reality experience; and, more particularly still, to systems, methods, and processes that can be utilized to produce an augmented reality experience for a remote customer via linked media.

### BACKGROUND

In 1901 author L. Frank Baum was one of the first to publicize the idea of an electronic display/spectacles that could overlay data onto a view of reality. However, the technology to bring it to fruition took decades to develop. It wasn't until the last 20-30 years that headsets, glasses, screens and similar devices began to be developed that would lay the foundation for the augmented reality devices available today. However, despite the various incarnations that are already available, the industry remains quite young, as only in very recent years has the necessary processing power, display resolution, sensing, portability and other required technological advances become generally available and accepted by consumers.

What is needed are systems and methods for producing an augmented reality (AR) experience for a remote customer via linked photographs and videos. Specifically, consumers are primed and ready for integration of AR into their lives as the availability and use of smart phones, tablets and other viewing devices is already at a very high level. Additionally, consumers are very comfortable taking photographs and videos and sharing them with friends and family, but the integration of AR in this scenario has been lacking. The present invention addresses these needs.

There are many other features and benefits of the systems, methods and processes of the present invention that will become apparent as the invention is explained in more detail below.

### SUMMARY

Systems, methods and processes utilizing the invention can begin with a consumer or user capturing a photograph (called a phase one photograph) as well as an associated video. The user does not have to utilize photos/videos that he or she takes himself or herself, but such are a part of an exemplary embodiment. In any case, the system can facilitate capture of either or both photos and videos via a user's smart phone, tablet, or other device (collectively, device). Alternatively, the system can utilize photos/videos (collectively, media) taken by a user's other equipment, or even an alternative device camera or video application on the same device. Once the user selects the media she wants to associate with the photograph, she simply uploads or otherwise transfers the media to a system server. The system can also capture the user's preferences for type of print, host material for the print, color vs. black and white, size, etc. The system then uses available information to create the print.

After the physical print has been created, a photograph of the print (called a phase two photograph) is made, as the simple act of printing the original phase one photograph onto a material changes the properties of the print to some degree. The system utilizes this phase two photograph to create a code of the image in order to uniquely identify the photograph. One method that can be employed to create a code is to scan the image and plot a large number of unique points thereof These plotted points can then be translated into a code which is associated with the video media that the user previously transferred to the system. The video is then made available on a system server for retrieval over a network. After code creation, the print is physically sent to the user who then presents it (on a wall, in a photo frame, as part of a larger work, etc.). Once the user has received the photograph print and presented it, the augmented reality experience is ready to be accessed. The user herself, or anyone who has access to the presented print (and/or additionally has a password or other security token), can then utilize the system on his or her device to display a live view of the world (non-augmented).

When the device is directed towards the presented image, the device will initially display the image and its surrounding background (e.g., the wall upon which the image is presented, for example). The system can constantly (or repeatedly) be scanning the camera feed of the device so that it very quickly recognizes the presented image as being a system image. The unique code for the presented image is quickly determined, communications across the network are made, the server sends the associated video to the device, and the system then begins playing the video in the location on the device's display where the photograph image was being displayed previously. The surrounding background (e.g., the wall surface) continues to be displayed as well, the difference is that instead of the device showing the photo image on the wall, it is now showing the associated video playing in the “space” that used to display the image. This displaying of a video in place of the associated image causes the “reality” that the user is viewing through the device to be augmented with the video experience rather than just showing the static photograph image that exists in reality on the wall; thus, providing the user with an augmented reality (AR) experience. The user can move their device around, and as long as a predetermined percentage of the device's screen still displays the space that holds the photograph image, the associated video can continue to be played.

The above summary provides a basic understanding of some aspects of the specification. This summary is not an extensive overview of the specification. It is intended to neither identify key or critical elements of the specification nor delineate any scope of particular embodiments of the specification, or any scope of the claims. Its sole purpose is to present some initial concepts in a simplified form as a prelude to the more detailed description that is presented later.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates exemplary systems that can be utilized in systems, methods and processes for producing an augmented reality for a remote customer via linked media;

FIG. 2 illustrates exemplary methods that can be utilized in systems, methods and processes for producing an augmented reality for a remote customer via linked media; and

FIG. 3 illustrates an exemplary embodiment of a computing system useful in implementations of the described technology.

### DETAILED DESCRIPTION

In the following discussion, numerous specific details are set forth to provide a thorough understanding of the present disclosure. However, those skilled in the art will appreciate that embodiments may be practiced without such specific details. Furthermore, lists and/or examples are often provided and should be interpreted as exemplary only and in no way limiting embodiments to only those examples. Similarly, in this disclosure, language such as “could, should, may, might, must, have to, can, would, need to, is, is not”, etc. and all such similar language shall be considered interchangeable whenever possible such that the scope of the invention is not unduly limited. For example, a comment such as: “item X is used” can be interpreted to read “item X can be used”.

Exemplary embodiments are described below in the accompanying Figures. The following detailed description provides a review of the drawing Figures in order to provide an understanding of, and an enabling description for, these embodiments. One having ordinary skill in the art will understand that in some cases well-known structures and functions have not been shown or described in detail to avoid unnecessarily obscuring the description of the embodiments. Further, examples described herein are intended to aid in understanding the principles of the embodiments, and are to be construed as being without limitation to such specifically recited examples and conditions. As a result, the inventive concepts are not limited to the specific embodiments or examples.

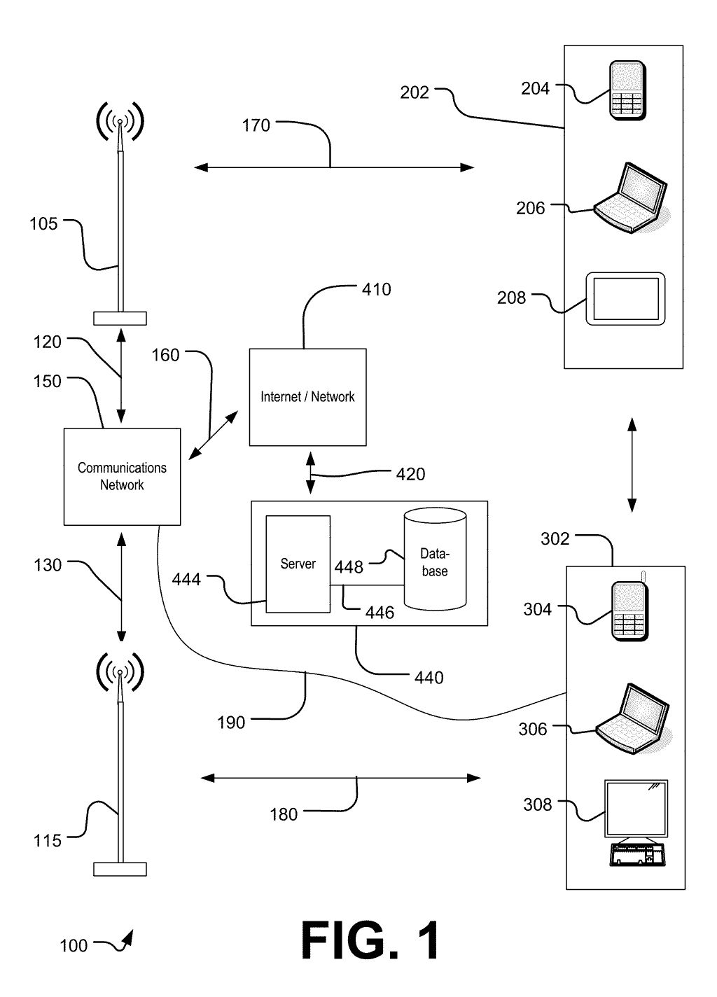

Referring now to the drawings, FIG. 1 illustrates exemplary systems that can be utilized in systems, methods and processes for producing an augmented reality for a remote customer via linked media 100. The systems in FIG. 1 include four groups of components: those labeled in the 100-199 range include the large-scale, often “public” communications systems; those in the 200-299 range include the mobile end-user devices; those in the 300-399 range include the fixed-location and mobile user devices; and those in the 400-499 range include the Internet/Network and server/database assets.

The large-scale, often “public” communications systems can include such items as cellular telephone towers 105 and 115, the public communications network 150 (and/or additional private systems), and the connection links and transmissions between and among such systems and the users thereof. The connections illustrated in FIG. 1 include: mobile connection links 170 between the mobile traveler cellular telephone tower 105 and the end-user mobile devices 202 (which can include intermediary connection devices); system transmission links 120 between the mobile traveler cellular tower 105 and the communications network 150; additional system transmission links 130 between the communications network 150 and the second cellular tower 115; mobile transmission links 180 between the second cellular tower 115 and the user devices 302; wired transmission links 190 between the communications network 150 and the user devices 302; and connection transmission links 160 between the communications network 150 and the Internet/Network 410.

The Internet/Network 410 can include any of the devices/networks that make up the Internet as well as private communications networks and devices that are utilized to allow the system equipment 440 to communicate with the communications network 150. The system equipment 440 can include a plurality of servers 444, a plurality of databases 448, and the system communication links 446 interconnecting them. The system equipment 440 hosts the apps and systems information, servers, etc. and makes them available for download to the end-users as well as storing, organizing, and developing the information databases that are built from data gathered/submitted by the end-users (and other sources) regarding photographs, video, media, user preferences, order history, payment info, etc. The system equipment 440 can also include all the systems necessary to produce the printed image prints, create the codes, associates the videos, serve the videos on demand, and process all data, orders, shipments, etc.

The end-user mobile devices 202 can include any mobile electronic device that can communicate with the systems. Examples of such devices include smart cellular telephones 204, portable computing devices 206, and tablet computers 208. Additional possible devices can include any device with a camera/sensor and a display screen such as GPS/location devices, mobile radio communications devices, dedicated tracking/location devices installed in cars/bicycles/etc., satellite communications devices, etc. A preferred embodiment of the invention includes a mobile end-user utilizing a smart phone 204 upon which the user has installed a system smart phone app. See later Figures and Descriptions for more information about exemplary embodiments.

The user devices 302 can include mobile devices as well as fixed-location devices. For example, users can employ cellular phones 304 or portable computing devices 306 and so be connected via mobile devices. Additionally, buddy users can employ less-mobile devices, sometimes referred to as “fixed-location” devices such as desktop computing devices 308 that may be connected via wired transmission links 190 to the communications network 150. Such devices can also (or alternatively) be connected via mobile transmission links 180; and although they are often more difficult to move around, they can be relocated and used in somewhat “mobile” ways (such as in a car, recreational vehicle, camper, etc.).

The exemplary systems illustrated in FIG. 1 allow the mobile and non-mobile end-user to communicate with the system equipment, such that the methods of the present invention can be carried out over the described systems.

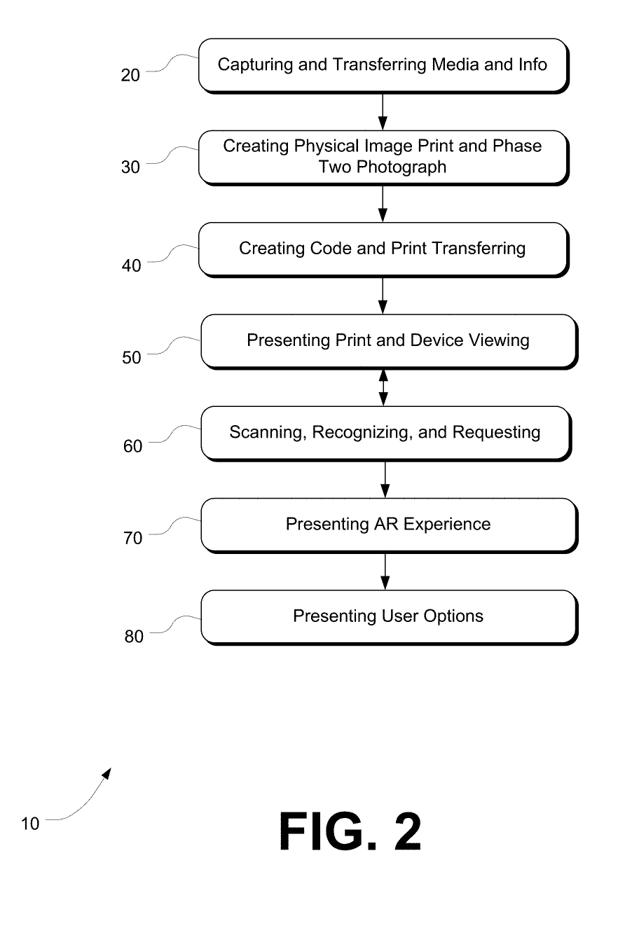

FIG. 2 illustrates exemplary methods that can be utilized in systems, methods and processes for producing an augmented reality for a remote customer via linked media 10. Systems, methods and processes utilizing the invention can begin with a consumer or user capturing a photograph (called a phase one photograph) as well as an associated video (collectively, media). The user does not have to utilize photos/videos that he or she takes themselves, but such are a part of an exemplary embodiment. In either case, the system can facilitate capture of either or both photos and videos via a user's smart phone, tablet, or other device (collectively, device). Alternatively, the system can utilize photos/videos (collectively, media) taken by a user's other equipment, or even an alternative device camera or video application on the same device. A system application or app may incorporate tools to help the customer take and edit their photo as well as tools to help them create their own video of the experience if they wish to utilize them. Once the user selects the media he wants to associate with the photograph, he simply uploads or otherwise transfers the media to a system server. In another embodiment, the system allows the user to send a photo only, without an associated video. The system can also capture the user's preferences for type of print, host material for the print, color vs. black and white, size, ordering and payment information, shipping information, etc. All of the above processes and methods can be encapsulated in the Capturing and Transferring Media and Info operation 20 of FIG. 2.

The system uses the information gathering in operation 20 to print the photo image per customer preferences. After the physical print has been created, a photograph of the print (called a phase two photograph) is made as the simple act of printing the original phase one photograph onto a material changes the properties of the print to some degree. The phase two photograph can be a scan, photo, or other data capture of the physical print. The above processes and methods can be encapsulated in the Creating Physical Image Print and Phase Two Photograph operation 30 of FIG. 2.

The system utilizes this phase two photograph to create a code of the image in order to uniquely identify the photograph. One method that can be employed to create a code is to scan the image and plot a large number of unique points thereof. These plotted points can then be translated into a code which is associated with the video media that the user previously transferred to the system. The video is then made available on a system server for retrieval over a network. After code creation, the print is physically sent to the user (utilizing information from operation 20) who then presents it (on a wall, in a photo frame, as part of a larger work, etc.). The above processes and methods can be encapsulated in the Creating Code and Print Transferring operation 40 of FIG. 2.

Once the user has received the photograph image print and presented it, the augmented reality experience is ready to be accessed. The user himself, or anyone who has access to the presented print (and/or additionally has a password or other security token), can then utilize the system on his or her device (e.g., a system mobile app) to display a live view of the world (non-augmented). When the device is directed towards the presented image, the device will initially display the image and its surrounding background (e.g., the wall upon which the image is presented, for example). The above processes and methods can be encapsulated in the Presenting Print and Device Viewing operation 50 of FIG. 2.

The system can constantly (or repeatedly) be scanning the camera feed of the device. The system is looking for any pattern that matches system codes. Once the system recognizes the presented image as being a system image and determines the correct code, it can communicate with other system assets (such as the servers/databases) and request the video associated with the code. These methods and processes are conducted very quickly so that the user can be immersed in the AR experience right away. The above processes and methods can be encapsulated in the Scanning, Recognizing, and Requesting operation 60 of FIG. 2.

Once the unique code for the presented image has been determined, requests across the network are made, and the server sends the associated video to the device requesting it. The system then begins playing the video in the location on the device's display where the photograph image was being displayed previously. The surrounding background (e.g., the wall surface) continues to be displayed as well, the difference is that instead of the device showing the photo image on the wall, it is now showing the associated video playing in the “space” that used to display the image. The system can enable the customer to simply tap a “full screen” button which will allow them to bring up the video in full screen so that if the do not wish to hold their device up over the photograph image any longer they will have the ability to do so while still watching the video. This displaying of a video in place of the associated image causes the “reality” that the user is viewing through the device to be augmented with the video experience rather than just showing the static photograph image that exists in reality on the wall. The above processes and methods can be encapsulated in the Presenting AR Experience operation 70 of FIG. 2.

Depending on options selected, the AR video can continue to play in a loop, it can prompt the user to play again, it can cycle between displaying the photo image and playing the video, etc. The user can move their device around, and as long as a predetermined percentage of the device's screen still displays the space that holds the photograph image, the associated video can continue to be played. In another embodiment, the video can stop when the device is pointed away from the AR image which will pause the video and present the option for a full screen. In yet another embodiment, when the system triggers the AR video it will play in real time within the space previously occupied by the image, but as the user moves away it will slowly pull up the full screen automatically. The above processes and methods can be encapsulated in the Presenting User Options operation 80 of FIG. 2.

In the embodiment illustrated in FIG. 2, a physical print image is utilized and sent to the user for presentation. In other embodiments, a digital print image, holographic image, or other type of image is sent to the user for display. Regardless of the form of the displayed image, it will contain the code necessary for the system to recognize it as a system image and trigger the playing of the associated video or similar media file.

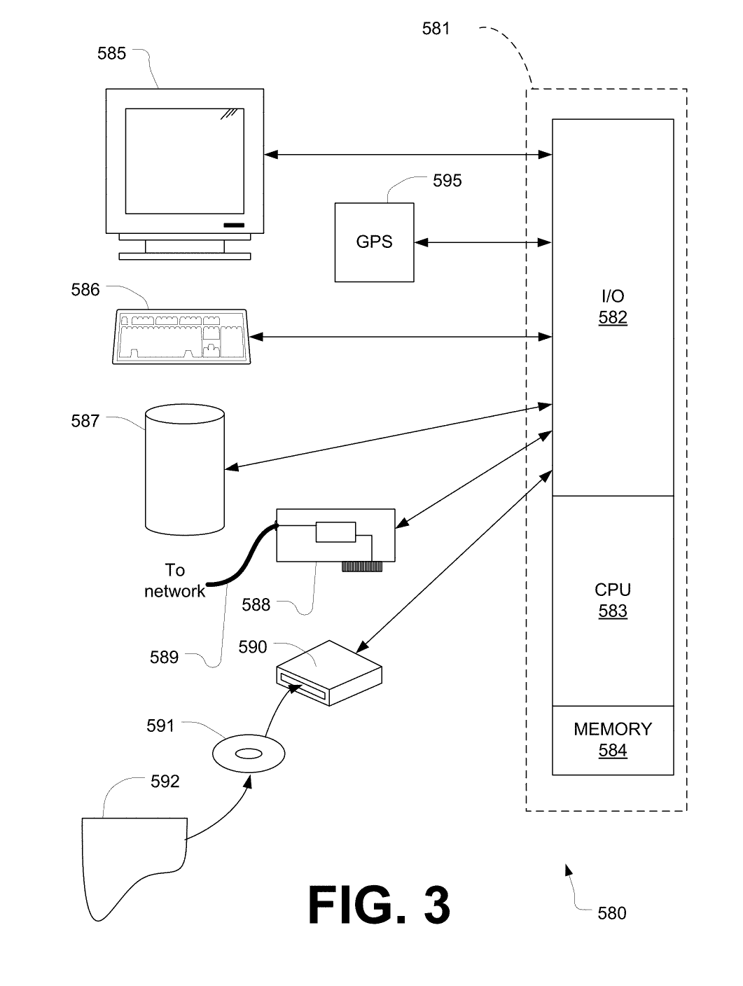

FIG. 3 illustrates an exemplary embodiment of a computing system 580 useful in implementations of the described technology. A general purpose computer system 580 is capable of executing a computer program product to execute a computer process. Data and program files may be input to the computer system 580, which reads the files and executes the programs therein. Some of the elements of a general purpose computer system 580 are shown in FIG. 3 wherein a processor 581 is shown having an input/output (I/O) section 582, a Central Processing Unit (CPU) 583, and a memory section 584. There may be one or more processors 581, such that the processor 581 of the computer system 580 comprises a single central-processing unit 583, or a plurality of processing units, commonly referred to as a parallel processing environment. The computer system 580 may be a conventional computer, a distributed computer, or any other type of computer. The described technology is optionally implemented in software devices loaded in memory 584, stored on a configured DVD/CD-ROM/OPTICAL DISC 591 or storage unit 587 (which can include SD cards, flash memory, etc.), and/or communicated via a wired or wireless network link 589 on a carrier signal, thereby transforming the computer system 580 in FIG. 4 into a special purpose machine for implementing the described operations. The computing system 580 provides a means for enabling the processor(s) 581 to access a plurality of modules in memory 584/storage 587 for the systems, methods and processes for producing an augmented reality for a remote customer via linked media. The computing system 580 further provides a second means for enabling the processor(s) 581 to implement the plurality of modules.

The I/O section 582 is connected to one or more user-interface devices (e.g., a keyboard 586 and a display unit 585 which could include touchscreen capabilities), a disk storage unit 587, and a disk drive unit 590. Generally, in contemporary systems, the disk drive unit 590 is a DVD/CD-ROM/OPTICAL drive unit capable of reading the DVD/CD-ROM/OPTICAL DISC medium 591, which typically contains programs and data 592. Said drive unit 590 may alternatively be a USB thumb drive, memory stick, or any other memory/storage medium. Computer program products containing mechanisms to effectuate the systems and methods in accordance with the described technology may reside in the memory section 584, on a disk storage unit 587, or on the DVD/CD-ROM/OPTICAL medium 591 of such a system 580. Alternatively, a disk drive unit 590 may be replaced or supplemented by a floppy drive unit, a tape drive unit, or other storage medium unit. A Global Positioning System (GPS) 595 can be accessed by the system 580 as well. The network adapter 588 is capable of connecting the computer system to a network via the network link 589, through which the computer system can receive instructions and data embodied in a carrier wave. Examples of such systems include portable computing devices such as smart phones, tablets, etc.; personal computers offered by Dell Corporation and by other manufacturers of personal computers, Apple-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 580 is connected (by wired connection or wirelessly) to a local network through the network interface or adapter 588, which is one type of communications device. When used in a WAN-networking environment, the computer system 580 typically includes a modem, a network adapter, or any other type of communications device for establishing communications over the wide area network. In a networked environment, program modules depicted relative to the computer system 580 or portions thereof, may be stored in a remote memory storage device. It is appreciated that the network connections shown are exemplary and other means of, and devices for, establishing a communications link between the computers may be used.

In accordance with an implementation, software instructions and data directed toward implementing systems, methods and processes for producing an augmented reality for a remote customer via linked media and other operations may reside on disk storage unit 587, disk drive unit 590 or other storage medium units having computer readable logic embodied in said storage medium and coupled to the system (directly and/or through a network interface 588). Said software instructions may also be executed by processor CPU 583. The embodiments of the disclosure described herein can be implemented as logical steps in one or more computer systems. The logical operations of the present disclosure can be implemented (1) as a sequence of processor-implemented steps executing in one or more computer systems and/or (2) as interconnected machine or circuit modules within one or more computer systems. The implementation is a matter of choice, dependent on the performance requirements of the computer system implementing the embodiment. Accordingly, the logical operations making up the embodiments described herein may be referred to variously as processes, services, threads, operations, steps, objects, or modules. Furthermore, it should be understood that logical operations may be performed in any order, unless explicitly claimed otherwise or a specific order is inherently necessitated by the claim language.

While particular embodiments have been described and disclosed in the present application, it is clear that any number of permutations, modifications, or embodiments may be made without departing from the spirit and the scope of this disclosure. Particular terminology used when describing certain features or aspects of the embodiments should not be taken to imply that the terminology is being redefined herein to be restricted to any specific characteristics, features, or aspects with which that terminology is associated. In general, the application should not be construed to be limited to the specific embodiments disclosed in the specification, unless the above Detailed Description section explicitly defines such terms. Accordingly, the actual scope of the inventions encompasses not only the disclosed embodiments, but also all equivalent ways of practicing or implementing the claimed subject matter.

The above detailed description of the embodiments is not intended to be exhaustive or to limit the disclosure to the precise embodiment or form disclosed herein or to the particular fields of usage mentioned above. While specific embodiments and examples are described above for illustrative purposes, various equivalent modifications are possible within the scope of the disclosure, as those skilled in the relevant art will recognize Also, the teachings of the embodiments provided herein can be applied to other systems, not necessarily the system described above. The elements and acts of the various embodiments described above can be combined to provide further embodiments.

Any patents, applications and other references that may be listed in accompanying or subsequent filing papers, are incorporated herein by reference. Aspects of embodiments can be modified, if necessary, to employ the systems, functions, and concepts of the various references to provide yet further embodiments.

In light of the above “Detailed Description,” the Inventor(s) may make changes to the disclosure. While the detailed description outlines possible embodiments and discloses the best mode contemplated, no matter how detailed the above appears in text, embodiments may be practiced in a myriad of ways. Thus, implementation details may vary considerably while still being encompassed by the spirit of the embodiments as disclosed by the Inventor(s). As discussed herein, specific terminology used when describing certain features or aspects should not be taken to imply that the terminology is being redefined herein to be restricted to any specific characteristics, features, or aspects of the embodiments with which that terminology is associated.

The above specification, examples and data provide a description of the structure and use of exemplary implementations of the described systems, articles of manufacture and methods. It is important to note that many implementations can be made without departing from the spirit and scope of the disclosure.

What is claimed is:

1. A method of producing an augmented reality experience for a remote customer via linked media, comprising:
capturing a plurality of media and transferring the plurality of media and related information to a system server;
creating a physical image print and a phase two capture of the physical image print;
creating a unique identifier image code of the phase two capture;
transferring the physical image print to the remote customer;
presenting the physical image print;
viewing the physical image print on a display screen on a device;
scanning the physical image print with the device, and wherein the device recognizes the physical image print as a system image via the unique identifier image code and requests associated media from the system server; and
presenting associated media to the device, and wherein the device presents an augmented reality experience to a user by displaying the associated media on the display screen of the device.

2. The method of claim 1, further comprising:
wherein the plurality of media includes at least a phase one photograph and an associated video and the associated media comprises the associated video.

3. The method of claim 1, further comprising:
presenting user options to the user.

4. The method of claim 2, further comprising:
presenting user options to the user.

5. The method of claim 1, further comprising:
the augmented reality experience further comprises displaying on demand the associated media on the device in place of the physical image print that would otherwise appear on the display screen of the device.

6. The method of claim 2, further comprising:
the augmented reality experience further comprises displaying on demand the associated media on the device in place of the physical image print that would otherwise appear on the display screen of the device.

7. The method of claim 3, further comprising:
the augmented reality experience further comprises displaying on demand the associated media on the device in place of the physical image print that would otherwise appear on the display screen of the device.

8. The method of claim 4, further comprising:
the augmented reality experience further comprises displaying on demand the associated media on the device in place of the physical image print that would otherwise appear on the display screen of the device.

9. A system for producing an augmented reality experience for a remote customer via linked media, comprising:
a system server that comprises a plurality of communicating computing systems, the system server accepts a plurality of captured media that is transferred to the system server;
a physical image print of at least one of the plurality of captured media and a phase two capture of the physical image print by the system server;
a unique identifier image code of the phase two capture created by the system server;
a display screen on a device that can sense and display an image of the physical image print;
wherein the device recognizes the physical image print as a system image via the unique identifier image code and requests associated media from the system server; and
wherein the associated media is displayed on the device as an augmented reality experience to a user, the augmented reality experience comprises displaying the associated media on the display screen of the device.

10. The system of claim 9, further comprising:
wherein the plurality of media includes at least a phase one photograph and an associated video and the associated media comprises the associated video.

11. The system of claim 9, further comprising:
the augmented reality experience further comprises displaying on demand the associated media on the device in place of the physical image print that would otherwise appear on the display screen of the device.

12. The system of claim 10, further comprising:
the augmented reality experience further comprises displaying on demand the associated media on the device in place of the physical image print that would otherwise appear on the display screen of the device.

13. A computer program product comprising a computer usable storage medium having computer readable logic embodied in said storage medium for enabling a processor to implement an application for producing an augmented reality experience for a remote customer via linked media, comprising:
first means for enabling the processor to access a plurality of modules in storage for the application;
second means for enabling the processor to implement the plurality of modules, the modules including at least:
a receiving a plurality of media module configured such that a system server can receive a plurality of captured media;
a creating print module configured to orchestrate the creation of a physical image print;
a phase two capture module configured to create a digital capture of the physical image print;
a create unique identifier image code module configured to create a unique identifier image code of the phase two capture;
a transferring the physical image print module configured to orchestrate the transfer of the physical image print to the remote customer;
a scan and recognize module that is configured to operate on a remote device, scan the surrounding of the device, recognize the physical image print as a system image via the unique identifier image code and request an associated media from the system server; and
a send module that is configured to receive requests from the remote device based on the unique identifier image code, locate and transfer the associated media to the device; and
a display augmented reality module that is configured on the device and presents an augmented reality experience to a user by displaying the associated media on the display screen of the device.

14. The computer program product of claim 13, further comprising:
wherein the plurality of media includes at least a phase one photograph and an associated video and the associated media comprises the associated video.
